(19) United States
(12) Patent Application Publication
(10) Pub. No.: US 2004/0235491 A1
(43) Pub. Date: Nov. 25, 2004

(54) Method and an apparatus for reducing signalling traffic in a telecommunication system

(76) Inventors: Anders Lundstrom, Karlstad (SE); Boo Shin, Tyreso (SE); Bertil Nilsson, Huddinge (SE)

Correspondence Address: NIXON & VANDERHYE, PC, 1100 N GLEBE ROAD, 8TH FLOOR, ARLINGTON, VA, 22201-4714, US

(21) Appl. No.: 10/315,251

(22) Filed: Dec. 10, 2002

(30) Foreign Application Priority Data
Jun. 19, 2002 (SE) 0002290-5
Jun. 15, 2001 (WO) PCT/SE01/01366

(51) Int. Cl. H04Q 7/20

(52) U.S. Cl. 455/456.1; 455/3.02; 455/41.1

(57) ABSTRACT

A method and an apparatus for updating the location of a plurality of mobile stations (107) in a moving craft or vehicle (105). Each time a new mobile station (107) is attached to a common terminal (103) located in the moving craft or vehicle, an initial location updating message is transmitted to a satellite system (101). Information based on the initial location updating message is then stored in the satellite system (101). When the common terminal (103) enters a new location area, a location updating message is transmitted including an identity of the common terminal (103). The satellite system (101) can then derive the new location for each of the attached mobile stations (107) based on the transmitted location updating message and the stored information on the mobile stations (107) currently being attached to the common terminal (103). In this way, the traffic load for location updating is significantly reduced, also providing communication access for a plurality of mobile stations in a moving craft or vehicle.

### TECHNICAL FIELD

The present invention relates to a method and an apparatus for providing efficient radio communication for plural mobile subscribers located in a moving craft or vehicle, such as an aircraft or a train. In particular, the invention is concerned with reducing signalling between the subscribers and a radio network.

### BACKGROUND OF THE INVENTION AND PRIOR ART

In aircrafts, it is typically not permitted to use GSM phones or other mobile phones. Satellite phones are often used instead. One example of satellite telephony is the ICO satellite system, providing radio communication in location areas corresponding to cells in mobile telephone networks.

However, it is desirable for subscribers to use their mobile phones onboard aircrafts or the like. In WO 9428684, it is described a system enabling the use of such phones in aircrafts. According to WO 9428684, mobile phones in an aircraft or a ship are connected to an onboard system via wires or an infra-red (IR) transmitter/receiver system. The onboard system then communicates over a wireless interface with external radio systems using a TFTS (Terrestrial Flight Telephony System) based communication link. U.S. Pat. No. 5,950,129 describes a similar solution including a procedure for transmitting a location updating message via a satellite system to a mobile network for a single mobile phone at a time.

Mobile communication standards typically require that the locations of mobile phones are updated in the network as they move between different location areas. When using a system according to WO 9428684 or U.S. Pat. No. 5,950,129 for mobile phones located in a fast travelling craft or vehicle, a problem may arise in that the required location updatings for the mobile phones will occur quite often. A great number of location updating messages would then have to be transmitted simultaneously if the craft or vehicle contains many mobile phone users. Thus, a potential overload of location updating signalling traffic will occur.

### SUMMARY

It is an object of the present invention to overcome the problems as outlined above by providing a method and a system having improved functions for handling traffic from mobile stations in moving crafts or vehicles.

This object and others are obtained by a method and an apparatus wherein a user of a mobile station, after entering a craft or vehicle, attaches and registers the mobile station to a common terminal located in the craft or vehicle. The common terminal provides a communication interface to a satellite system, for example the ICO satellite system. The mobile station may be attached to the common terminal by using a wireline or a wireless connection.

When the mobile station is attached to the common terminal, the terminal transmits an initial location updating message to the satellite system, indicating that the mobile station is now attached to the common terminal. When another, second, user of a mobile station has entered the craft or vehicle, the second mobile station is also attached to the common terminal, and so on.

Thus, each time a new mobile station is attached to the common terminal, an initial location updating message is transmitted to the satellite system. Information based on the initial location updating message is stored in the satellite system until the mobile station leaves the craft or vehicle and is detached from the common terminal. A detaching message is then transmitted from the common terminal, informing the satellite system that the mobile station is no longer attached to the common terminal and the mobile station is detached from the satellite system.

When the common terminal enters a new location area in the satellite network, a location updating message is transmitted to the satellite system, comprising only its own identity. The satellite network can then implicitly update the location of all mobile stations registered in or attached to the common terminal, based on the transmitted location updating message and the stored information on which mobile stations that are currently attached to the common terminal.

Thus, the common terminal only needs to transmit one single location updating message for all mobile stations attached thereto in order to simultaneously update the location of each mobile station. Thus, the amount of air-interface signalling, signalling towards the VLRs (Visiting Location Register) and towards the HLRs (Home Location Register) will be significantly reduced.

### BRIEF DESCRIPTION OF THE DRAWINGS

The present invention will now be described in more detail and with reference to the accompanying drawings, in which:

FIG. 1 is a general view of a telecommunication system in which the present invention may be implemented.

FIG. 2 is an exemplary signalling diagram illustrating signalling messages transmitted when attaching a mobile station to the system shown in FIG. 1.

FIG. 3 is an exemplary signalling diagram illustrating signalling messages transmitted when performing location updating for a plurality of mobile stations simultaneously.

### DESCRIPTION OF PREFERRED EMBODIMENTS

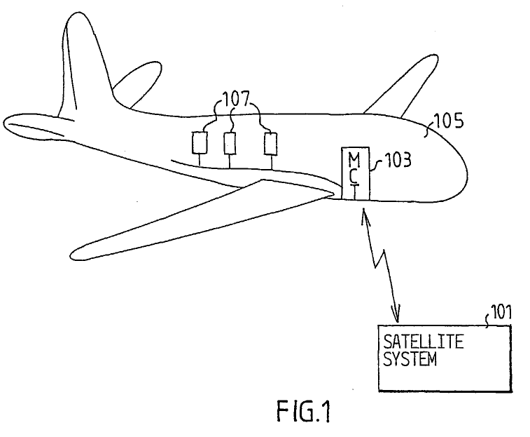

In FIG. 1, a general view of a telecommunication system is shown. The telecommunication system comprises a satellite system 101 which in turn can be connected to a cellular mobile system, not shown, such as a GSM network. The telecommunication system in FIG. 1 further comprises a multi-channel terminal (MCT) 103 and a plurality of mobile stations (MS) 107, the MCT 103 and the MSs 107 being located in an aircraft 105. However, the MCT 103 and the MSs 107 may alternatively be located in any moving craft or vehicle, such as a train, bus or boat, carrying users of mobile stations. In particular, the invention is advantageously used for providing communication access for mobile stations where these otherwise normally cannot be used, for example due to restrictions or lack of radio coverage.

The MCT 103 is a common terminal to which mobile stations can be attached, using a local access technique, such as a wireline connection, an Infrared (IR) connection or a Bluetooth™ connection. However, the invention is not limited to any particular access technique for attaching mobile stations to the common terminal MCT 103. The MCT 103 further comprises radio equipment, not shown, for radio communication with the satellite system 101. In the exemplary embodiment shown in FIG. 1, the MCT 103 is installed in an aircraft 105 for enabling telecommunication with the surrounding world for the MSs 107.

In the example shown in FIG. 1, the MCT 103 supports the GSM standard. However, other cellular standards may alternatively be supported. Furthermore, the satellite system 101 with which the MCT 103 communicates, generally supports multi-channel terminals, such as the MCT 103. The MCT 103 provides, e.g., multiple extensions and direct dialling to and from each individual extension.

In the example where GSM based MSs 107 are used, each MS 107 is capable of performing SIM (Subscriber Identity Module) based roaming in the mobile network. Thus, using the GSM SIM card, each subscriber may receive calls directed to their home network number and may be billed via their usual service provider for telephone services used onboard the aircraft. Furthermore, the subscriber will have access to the same functions and services as usual.

If individual signalling traffic were to be conducted for each roaming MS 107 in the aircraft 105, there would be a potential risk of traffic overload in the satellite system 101, since many mobile stations change location simultaneously. In order to solve this problem, the MCT 103 has a function for performing simultaneous location updating for all MSs 107 attached to the MCT 103 using one single location updating message for all the attached MSs 107. The MCT 103 will thus act as a common terminal for the attached MSs 107 towards the satellite system 101.

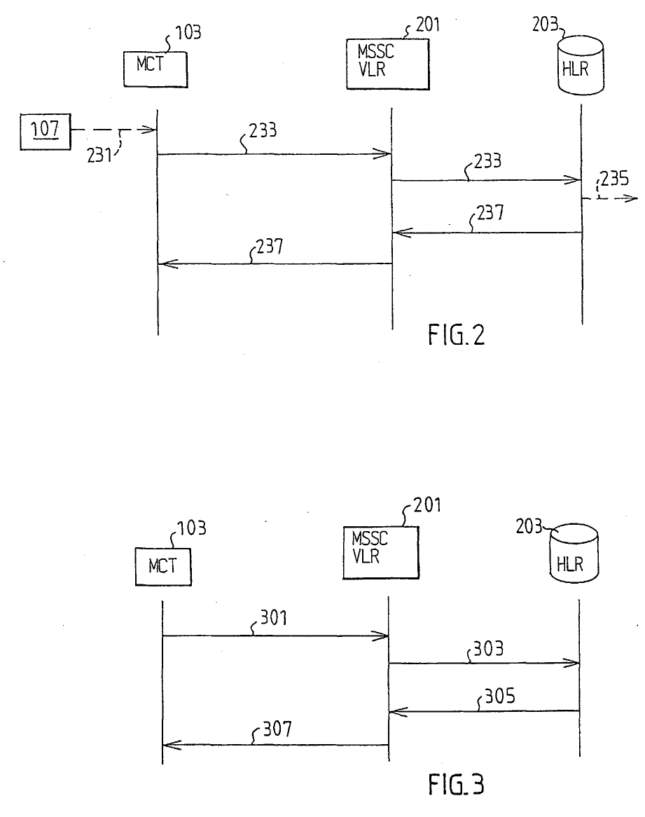

In FIG. 2, a signalling diagram illustrating different signalling messages being transmitted in the telecommunication system shown in FIG. 1 for performing an initial location update for an MS 107 as it is attached to the MCT 103 in the aircraft 105. The MS 107, in this example a GSM mobile station, is first attached to the MCT 103, as indicated by the dashed line 231. In response to the attachment of the MS 107, an initial location updating message 233 is transmitted by the MCT 103 to a Mobile Satellite Service Switching Centre (MSSC) 205 belonging to the satellite system 101. The message 233 is then forwarded to an HLR. (Home Location Register) 203, likewise belonging to the satellite system. The message 233 comprises an identity of the MCT 103, for example a GSM International Mobile Subscriber Identity (IMSI) of the MCT 103, and an identity of the MS 107, for example the IMSI of the MS 107. The message 233 is then further forwarded to the HLR, not shown, belonging to the GSM home network of the MS 107, as indicated by the dashed line 235. The HLR of the GSM home network will then store data indicating that the MS 107 is attached to the MCT 103. The HLR 203 of the satellite system may optionally return an acknowledgement message 237 to the MCT 103.

This procedure is repeated for each MS 107 being attached to the MCT 103, and the satellite system 101 stores the identity of each attached MS 107.

When the MCT 103, and hence all MSs 107 attached thereto, enters a new location area as the aircraft 105 moves, location updating is typically required for each attached MS 107. The following procedure is then performed, with reference to FIG. 3. First, a message 301 comprising the identity, e.g., IMSI, of the MCT 103 is transmitted from the MCT 103 to the MSSC 201, which in turn sends a location updating message 303 to the HLR 203 of the satellite system 101. The new location of the MCT 103 is then stored in the HLR 203 of the satellite system 101. The HLR 203 may optionally return an acknowledgement message 305 to the MSSC 205, which then sends a corresponding acknowledgement message 307 to the MCT 103.

By using the location information from the MCT 103 being stored in the HLR 203 of the satellite system 101, together with the likewise stored information on which mobile stations that are currently connected to the MCT 103, the satellite system 101 can derive the new location for each of all the MSs 107 being attached to the MCT 103. The signalling traffic from the MCT 103 to the satellite system 101 is thereby considerably reduced, since only one common location updating message containing only the identity of the MCT 103 is required.

Furthermore, location updating messages may be transmitted periodically for the MCT 103, being valid for all MSs 107 currently being attached thereto. By performing periodic updatings in this way simultaneously for all the attached MSs 107, using one single location updating message and only the identity of the MCT 103, the signalling load is further reduced.

Using the above described procedure will significantly reduce the traffic load in a system providing mobile communication access for a plurality of subscribers using mobile stations in a moving vehicle or craft. In particular, the procedure is useful in situations where mobile stations normally cannot be used, such as in an aircraft or a train, due to restrictions or lack of radio coverage by a cellular mobile system. All required air interface signalling with the satellite system is then performed by means of the radio equipment of the multi-channel terminal and can be controlled such that no interference with other radio communications will occur. Furthermore, the radio equipment of the multi-channel terminal may be designed for communication over much longer distances and/or for difficult radio conditions, compared with the design of handheld mobile stations.

While the invention has been described with reference to specific exemplary embodiments, the description is only intended to illustrate the inventive concept and should not be taken as limiting the scope of the invention. Various alternatives, modifications and equivalents may be used without departing from the spirit of the invention, which is defined by the appended claims.

1. A method of updating the location of a plurality of mobile stations (107) in a moving craft or vehicle, wherein a common terminal (103) in the craft or vehicle provides a communication interface between the mobile stations (107) and a satellite communication system (101), characterised by the steps of:
A) transmitting an initial location updating message to the satellite system (101) each time a mobile station (107) is attached to the common terminal (103), wherein the initial location updating message includes an identity of the common terminal (103) and an identity of the attached mobile station (107),
B) storing in the satellite system (101) information on the mobile stations (107) currently being attached to the common terminal (103) based on the transmitted initial location updating message, and
C) transmitting a location updating message from the common terminal (103) to the satellite system (101) including the identity of the common terminal (103),
wherein the satellite system (101) can derive the new location for each of the attached mobile stations (107) based on the location updating message transmitted in step C) and the information stored in step B).

2. A method according to claim 1, characterised in that the location updating message of step C) is transmitted when the common terminal (103) enters a new location area, wherein the location updating message is valid for all mobile stations (107) currently being attached to the common terminal (103).

3. A method according to claim 1, characterised in that the location updating message of step C) is transmitted periodically, wherein the location updating message is valid for all mobile stations (107) currently being attached to the common terminal (103).

4. A method according to any of claims 1-3, wherein the common terminal (103) supports mobile stations according to the GSM standard, characterised in that the identity of the common terminal (103) is an IMSI of the common terminal (103) and the identities of the attached mobile stations (107) are IMSIs of the respective attached mobile stations (107).

5. A method according to any of claims 1-4, characterised in that the mobile stations (107) are attached to the common terminal (103) by using any of: a wireline connection, an Infrared (IR) connection and a Bluetooth™ connection.

6. A system for updating the location of a plurality of mobile stations (107) in a moving craft or vehicle, the system comprising a satellite communication system (101) and a common terminal (103) in the craft or vehicle for providing a communication interface between the mobile stations (107) and the satellite system (101), characterised in that:
the common terminal (103) comprises means for transmitting an initial location updating message to the satellite system (101) each time a mobile station (107) is attached to the common terminal (103), wherein the initial location updating message includes an identity of the common terminal (103) and an identity of the attached mobile station (107),
the satellite system (101) comprises means for storing information on the mobile stations (107) currently being attached to the common terminal (103) based on the initial location updating message, and that
the common terminal (103) further comprises means for transmitting a location updating message to the satellite system (101) including the identity of the common terminal (103),
wherein the satellite system (101) can derive the new location for each of the attached mobile stations (107) based on the transmitted location updating message from the common terminal (103) and the stored information on the mobile stations (107) currently being attached to the common terminal (103).

7. A system according to claim 6, characterised in that the common terminal (103) transmits the location updating message when entering a new location area, wherein the location updating message is valid for all mobile stations (107) currently being attached to the common terminal (103).

8. A system according to claim 6, characterised in that the common terminal (103) transmits the location updating message periodically, wherein the location updating message is valid for all mobile stations (107) currently being attached to the common terminal (103).

9. A system according to any of claims 6-8, wherein the common terminal (103) supports mobile stations according to the GSM standard, characterised in that the identity of the common terminal (103) is an IMSI of the common terminal (103) and the identities of the attached mobile stations (107) are IMSIs of the respective attached mobile stations (107).

10. A system according to any of claims 6-9, characterised in that the mobile stations (107) are attached to the common terminal (103) by using any of: a wireline connection, an Infrared (IR) connection and a Bluetooth™ connection.

11. A common terminal (103) for updating the location of a plurality of mobile stations (107) in a moving craft or vehicle, wherein the common terminal (103) provides an interface between the mobile stations (107) and a satellite communication system (101), characterised in that the common terminal (103) comprises:
means for transmitting an initial location updating message to the satellite system (101) each time a mobile station (107) is attached to the common terminal (103), wherein the initial location updating message includes the identity of the common terminal (103) and the identity of the attached mobile station (107), and
means for transmitting a location updating message from the common terminal (103) to the satellite system (101) comprising the identity of the common terminal (103) when a location update is required.

12. A common terminal (103) according to claim 11, characterised in that the common terminal (103) transmits the location updating message when entering a new location area, wherein the location updating message is valid for all mobile stations (107) currently being attached to the common terminal (103).

13. A common terminal (103) according to claim 11, characterised in that the common terminal (103) transmits the location updating message periodically, wherein the location updating message is valid for all mobile stations (107) currently being attached to the common terminal (103).

14. A common terminal (103) according to any of claims 11-13, wherein the common terminal (103) supports mobile stations according to the GSM standard, characterised in that the identity of the common terminal (103) is an IMSI of the common terminal (103).

15. A common terminal (103) according to any of claims 11-14, characterised in that the mobile stations (107) are attached to the common terminal (103) by using any of: a wireline connection, an Infrared (IR) connection and a Bluetooth™ connection.
